(19) United States
(12) Patent Application Publication
(10) Pub. No.: US 2026/0184116 A1
(43) Pub. Date: Jul. 2, 2026

(54) PNEUMATIC TIRE

(71) Applicant: Toyo Tire Corporation, Itami-shi (JP)

(72) Inventor: Itsuki OYAMA, Itami-shi (JP)

(21) Appl. No.: 19/425,300

(22) Filed: Dec. 18, 2025

(30) Foreign Application Priority Data
Dec. 27, 2024 (JP) 2024-232838

(51) Int. Cl. B60C 11/13; B60C 11/03; B60C 11/12

(52) U.S. Cl. CPC B60C 11/1323; B60C 11/1204; B60C 2011/0341; B60C 2011/1213

(57) ABSTRACT

A tread includes a center main groove extending in a tire circumferential direction, and a shoulder main groove; in at least one of the center main groove and the shoulder main groove, an inclination angle of a groove wall on an outer side in a tire axial direction is smaller than an inclination angle of a groove wall on an inner side in the tire axial direction; each of beads includes a bead core and a bead filler extending outward from the bead core in a tire radial direction; and a steel reinforcement layer including steel cords is placed outward of the bead filler in the tire axial direction.

### CROSS REFERENCE TO RELATED APPLICATION

The entire disclosure of Japanese Patent Application No. 2024-232838 filed on Dec. 27, 2024, including the specification, claims, drawings, and abstract, is incorporated herein by reference in its entirety.

### TECHNICAL FIELD

The present disclosure relates to a pneumatic tire.

### BACKGROUND

Conventionally, a pneumatic tire is known that includes a tread including a center main groove extending in a tire circumferential direction, shoulder main grooves placed outward of the center main groove in a tire axial direction and extending in the tire circumferential direction, and a land portion partitioned by respective main grooves (see, for example, JP 2018-131003 A). JP 2018-131003 A discloses a pneumatic tire that includes a tread including a land portion provided with lug grooves formed to extend in a direction that intersects a main groove, for the purpose of improving drainage performance while securing noise performance.

### SUMMARY

### Technical Problem

In recent years, to improve the fuel efficiency of automobiles, there has been an increasing demand for reducing the weight of tires. As a method for reducing the weight, it is conceivable to reduce the thickness of structural members (e.g., a tread, a sidewall, and the like) of a tire. On the other hand, thinning the structural members of the tire tends to decrease the lateral rigidity of the tire, resulting in decreased steering stability. Furthermore, thinning the tread tends to impair drainage performance as the groove volume of the main grooves decreases, thereby deteriorating wet performance. Therefore, even if the reduction of the thickness and weight of the structural members of the tire is achieved, technologies for improving steering stability and drainage performance are still required.

### Solution to Problem

A pneumatic tire according to an aspect of the present disclosure is a pneumatic tire comprising: a tread, a pair of sidewalls arranged on opposite sides of the tread, a pair of beads arranged inward of the sidewalls in a tire radial direction, and a carcass ply extended between the pair of beads, wherein the tread is provided with a center main groove extending in a tire circumferential direction, and a shoulder main groove placed outward of the center main groove in a tire axial direction, and extending in the tire circumferential direction; in at least one of the center main groove and the shoulder main groove, an inclination angle of a groove wall on an outer side in the tire axial direction, relative to a normal perpendicular to a profile surface of the tread, is smaller than an inclination angle of a groove wall on an inner side in the tire axial direction, relative to the normal perpendicular to the profile surface of the tread; each of the beads includes a bead core and a bead filler extending outward from the bead core in the tire radial direction; and a steel reinforcement layer including steel cords is placed outward of the bead filler in the tire axial direction.

### Advantageous Effects of Invention

A pneumatic tire of one aspect of the present disclosure can improve steering stability and drainage performance even with reduced thickness and weight of structural members of the tire.

### BRIEF DESCRIPTION OF DRAWINGS

Embodiments of the present disclosure will be described based on the following figures, wherein:

FIG. 1 is a cross-sectional view of a pneumatic tire that is an example of an embodiment;

FIG. 2 is an enlarged view of part A in FIG. 1;

FIG. 3 is a plan view of a tread of the pneumatic tire that is the example of the embodiment;

FIG. 4 is a cross-sectional view taken along line AA in FIG. 3; and

FIG. 5 is a cross-sectional view taken along line BB in FIG. 3.

### DESCRIPTION OF EMBODIMENTS

Hereinafter, with reference to the drawings, an example of an embodiment of a pneumatic tire according to the present disclosure will be described in detail. The embodiment described below is merely an example, and the present disclosure is not limited to the following embodiment. Furthermore, the present disclosure includes a form comprising respective components of the embodiment described below that are selectively combined.

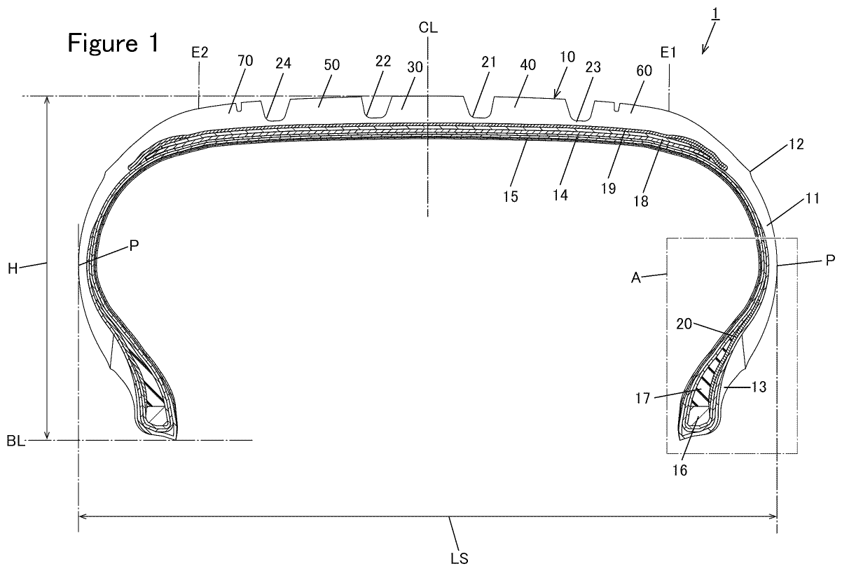

FIG. 1 is a cross-sectional view of a pneumatic tire 1 that is an example of the embodiment. As shown in FIG. 1, the pneumatic tire 1 includes a tread 10 that is a portion in contact with a road surface, a pair of sidewalls 11 arranged on opposite sides of the tread 10, and a pair of beads 13 arranged inward of the sidewalls 11 in a tire radial direction. Furthermore, the pneumatic tire 1 further includes a carcass ply 14 extended between the pair of beads 13 and an inner liner 15 placed inward of the carcass ply 14 in the tire radial direction. The pneumatic tire 1 has excellent performance not only on a dry road surface but also on a wet road surface and snowy and icy road surfaces, and is suitable for an all-season tire.

In the present embodiment, the mounting direction of the pneumatic tire 1 on a vehicle is not specified, and the pneumatic tire is a point-symmetrical tire in which a tread pattern and the shape of a tire side surface remain unchanged regardless of the direction in which the tire is mounted on the vehicle. That is, the tread pattern and the shape of the tire side surface of the pneumatic tire 1 are formed in such a manner that they are rotated 180 degrees on either side of the tire equator CL. Here, the tire equator CL is a virtual line in a tire circumferential direction and passing through a middle portion of the tread 10 in the tire axial direction.

The tread 10 includes a pair of center main grooves 21 and 22 extending in the tire circumferential direction, and a pair of shoulder main grooves 23 and 24 provided outward of the center main grooves 21 and 22 in the tire axial direction, the shoulder main grooves extending in the tire circumferential direction. The four main grooves are formed straight in the tire circumferential direction, without bending in the tire axial direction.

Furthermore, the tread 10 includes a center land portion 30 partitioned by the pair of center main grooves 21 and 22 and formed on the tire equator CL, a first middle land portion 40 partitioned by the center main groove 21 and the shoulder main groove 23, and a second middle land portion 50 partitioned by the center main groove 22 and the shoulder main groove 24. Furthermore, the tread 10 includes a first shoulder land portion 60 placed opposite the first middle land portion 40 via the shoulder main groove 23 in the tire axial direction, and a second shoulder land portion 70 placed opposite the second middle land portion 50 via the shoulder main groove 24 in the tire axial direction. The first shoulder land portion 60 and the second shoulder land portion 70 are formed beyond ground contact ends E1 and E2. The land portion is a portion raised outward from a position corresponding to the bottom of the main groove in the tire radial direction.

In the present embodiment, the ground contact ends E1 and E2 of the pneumatic tire 1 are defined as opposite ends of a region (ground contact surface) in contact with a flat road surface in the tire axial direction. This definition applies when an unused tire is mounted on the rim of a set vehicle, filled with air to reach an internal pressure set to the vehicle, and subjected to a vehicle axial load.

The sidewalls 11 are arranged on opposite sides of the tread 10 and are provided in an annular shape in the tire circumferential direction. Each sidewall 11 is a portion that protrudes furthest outward in the tire axial direction in the pneumatic tire 1 and is gently curved to be convex toward an outer side in the tire axial direction. The sidewall 11 has a function of preventing damage to the carcass ply 14. The sidewall 11 is the most deformable portion when the pneumatic tire 1 performs a cushioning function and is typically made of flexible rubber having fatigue resistance.

The pneumatic tire 1 may include a side rib 12 provided between the ground contact ends E1, E2 of the tread 10 and the portion of the sidewall 11 that protrudes furthest outward in the tire axial direction. The side rib 12 protrudes outward in the tire axial direction and is provided in an annular shape in the tire circumferential direction. The portions of the pneumatic tire 1 from the ground contact ends E1 and E2 or from regions close to the ground contact ends E1 and E2, to the left and right side ribs 12, are also referred to as buttress regions.

Furthermore, the sidewall 11 is generally provided with letters, numbers, symbols, and the like referred to as serial information. The serial information includes, for example, a size code, a manufacturing date (manufacturing year/week), and a manufacturing location (manufacturing plant code).

The bead 13 is a portion placed inward of the sidewall 11 in the tire radial direction and fixed to a rim of a wheel. The bead 13 includes a bead core 16 and a bead filler 17. The bead core 16 is an annular member composed of a steel bead wire and extending over the entire circumference in the tire circumferential direction and is embedded in the bead 13. The bead filler 17 is an annular hard rubber member with a tapered tip shape that extends outward in the tire radial direction, the rubber member extending over the entire circumference in the tire circumferential direction. As will be described in detail later, a steel reinforcement layer 20 including steel cords is placed outward of the bead filler 17 in the tire axial direction.

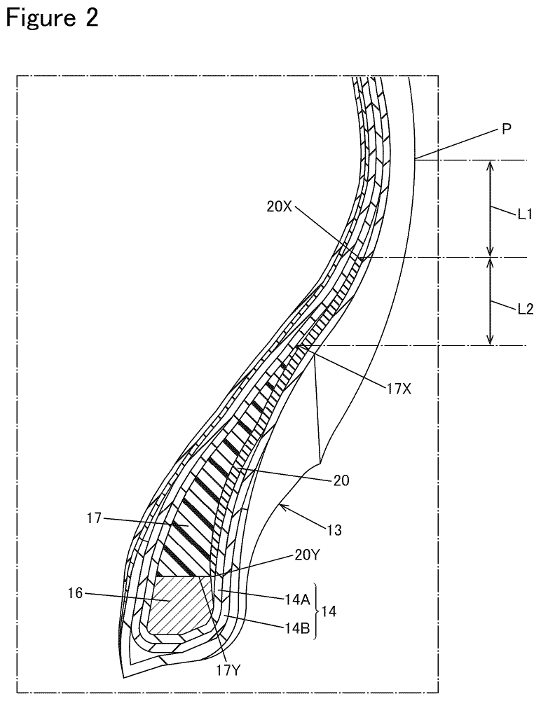

The carcass ply 14 is extended between a pair of beads 13 and secured by being folded around the bead core 16. In the present embodiment, the carcass ply 14 includes two carcass plies 14A and 14B (see FIG. 2). The carcass ply 14 includes a carcass ply cord made of organic fibers and a topping rubber. The carcass ply cord is placed at substantially right angles to the tire circumferential direction (e.g., 80° or more, and 90° or less). Examples of the organic fibers for use in the carcass ply cord include polyester fibers, rayon fibers, aramid fibers, and nylon fibers.

The inner liner 15 covers an inner surface of the tire between the pair of beads 13. The inner liner 15 is composed of air permeation resistant rubber and has a function of maintaining the air pressure of the pneumatic tire 1.

Furthermore, the pneumatic tire 1 further includes a belt 18 disposed outward of the carcass ply 14 in the tire radial direction and a cap ply 19 covering the outer side of the belt 18 in the tire radial direction. The cap ply 19 has a function of reinforcing the belt 18. The number of cap plies 19 may be one or two, or two or more.

The belt 18 is placed outward of a top portion of the carcass ply 14 in the tire radial direction and is superimposed on the outer peripheral surface of the carcass ply 14. The belt 18 is formed of a belt ply made by coating, with rubber, cords arranged in a direction inclined relative to the tire circumferential direction. The material of the belt ply cord is not particularly limited, and examples thereof include organic fibers such as polyester, rayon, nylon, and aramid, and metals such as steel.

As shown in FIG. 1, a ratio (H/LS) of a tire cross-sectional height H based on a bead baseline BL to a tire cross-sectional maximum width LS is preferably 0.48 or more and 0.60 or less. When the steel reinforcement layer 20 is provided outward of the bead filler 17 in the tire axial direction, longitudinal rigidity of the tire may increase. Controlling a tire shape so that the ratio (H/LS) is 0.48 or more and 0.60 or less can help prevent increase in longitudinal rigidity of the tire, absorb unevenness on the road surface, and improve ride comfort.

Furthermore, the tire cross-sectional maximum width LS refers to a length in the tire axial direction between two positions (tire maximum width positions P) on opposite sides of the sidewall 11 that protrude furthest in the tire axial direction, measured in an unloaded state where the pneumatic tire 1 is mounted on a specified rim and inflated to reach an internal pressure of 0 kPa. In addition, the tire cross-sectional height H refers to a length in the tire radial direction from the bead baseline BL to the outer surface of the tread 10 at the position of the tire equator CL, measured in the unloaded state where the pneumatic tire 1 is mounted on the specified rim and inflated to reach the internal pressure of 0 kPa. Here, the bead baseline BL is a virtual straight line in the tire axial direction that defines a rim diameter of a standard rim.

Next, with reference to FIG. 2, the steel reinforcement layer 20 will be described. FIG. 2 is an enlarged view of part A in FIG. 1, showing the configuration of the vicinity of the steel reinforcement layer 20.

As shown in FIG. 2, the steel reinforcement layer 20 including the steel cords is placed outward of the bead filler 17 in the tire axial direction. The steel reinforcement layer 20 is placed between the bead filler 17 and the folded carcass ply 14 and provided in an annular shape in the tire circumferential direction. Providing the steel reinforcement layer 20 outward of the bead filler 17 in the tire axial direction can improve lateral rigidity. As a result, wobbling is less likely to occur during turning, for example, and steering stability can be improved. To reduce the weight of the tire, the thickness of a structural member such as the tread 10 or the sidewall 11 may be reduced. This reduction, however, tends to decrease the lateral rigidity of the tire, and the lateral rigidity of the tire can be maintained by providing the steel reinforcement layer 20.

The steel reinforcement layer 20 is composed of the steel cords (not shown) covered with coating rubber or the like. The steel cords extend to be inclined relative to the tire radial direction and are spaced apart in the tire circumferential direction while maintaining this inclined orientation. An inclination angle of the steel cords relative to the tire radial direction is not particularly limited and is, for example, 10° or more and 45° or less. Furthermore, the steel cords have a cord diameter that is not particularly limited, and the cord diameter is, for example, 0.3 mm or more and 1.2 mm or less, and may be 0.5 mm or more and 0.9 mm or less.

The number of steel cords driven in the steel reinforcement layer 20 is preferably 15 cords/inch or more and 25 cords/inch or less, and more preferably 17 cords/inch or more and 23 cords/inch or less. If the number of steel cords driven is within the above range, both the longitudinal rigidity and the lateral rigidity of the tire can be readily secured.

As shown in FIG. 2, the steel reinforcement layer 20 has a tire radial outer end 20X located inside the tire maximum width position P in the tire radial direction. This can help prevent excessive increase in longitudinal rigidity of the tire, absorb unevenness on the road surface, and improve ride comfort. A length L1 in the tire radial direction from the tire radial outer end 20X of the steel reinforcement layer 20 to the tire maximum width position P is, for example, 3 mm or more and 15 mm or less, and may be 5 mm or more and 10 mm or less.

Furthermore, the tire radial outer end 20X of the steel reinforcement layer 20 is placed outward of a tire radial outer end 17X of the bead filler 17 in the tire radial direction. This can increase strength of a tire side surface and improve the lateral rigidity. In addition, by offsetting and arranging the tire radial outer end 20X of the steel reinforcement layer 20 from the tire radial outer end 17X of the bead filler 17, stress concentration around the tire radial outer end 17X of the bead filler 17 can be suppressed, thus improving durability. From the viewpoint of further improving the lateral rigidity, a length L2 in the tire radial direction from the tire radial outer end 20X of the steel reinforcement layer 20 to the tire radial outer end 17X of the bead filler 17 is preferably 5 mm or more, and further preferably 6 mm or more.

Furthermore, if the length L2 in the tire radial direction from the tire radial outer end 20X of the steel reinforcement layer 20 to the tire radial outer end 17X of the bead filler 17 is excessively large, the longitudinal rigidity may increase excessively. Consequently, the length L2 in the tire radial direction from the tire radial outer end 20X of the steel reinforcement layer 20 to the tire radial outer end 17X of the bead filler 17 is preferably 10 mm or less, and further preferably 9 mm or less. Therefore, the length L2 in the tire radial direction from the tire radial outer end 20X of the steel reinforcement layer 20 to the tire radial outer end 17X of the bead filler 17 is preferably 5 mm or more and 10 mm or less, and more preferably 6 mm or more and 9 mm or less.

In the example shown in FIG. 2, a tire radial inner end 20Y of the steel reinforcement layer 20 and a tire radial inner end 17Y of the bead filler 17 are aligned to substantially overlap each other in the tire radial direction. This increases the strength of the tire side surface and improves the lateral rigidity. Furthermore, the tire radial inner end 20Y of the steel reinforcement layer 20 may be placed outward of the tire radial inner end 17Y of the bead filler 17 in the tire radial direction. In this case, a length in the tire radial direction from the tire radial inner end 20Y of the steel reinforcement layer 20 to the tire radial inner end 17Y of the bead filler 17 is preferably 5 mm or less, and more preferably 3 mm or less.

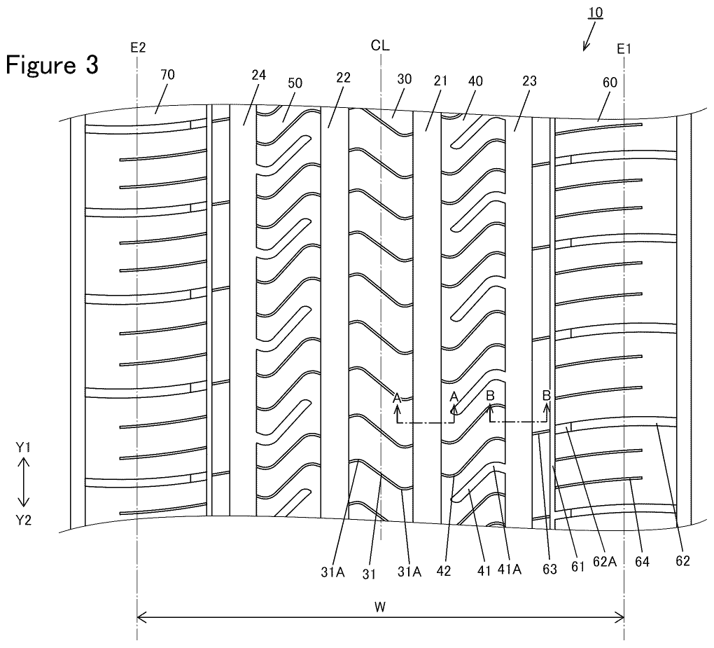

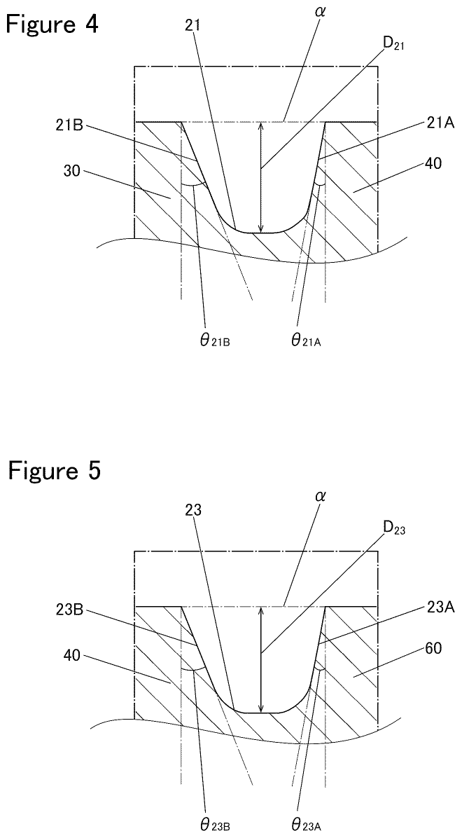

Next, with reference to FIGS. 3 to 5, a tread pattern of the pneumatic tire 1 will be described. FIG. 3 is a plan view of the pneumatic tire 1 (tread 10), FIG. 4 is a cross-sectional view taken along line AA in FIG. 3, and FIG. 5 is a cross-sectional view taken along line BB in FIG. 3.

As shown in FIG. 3, the tread 10 includes the pair of center main grooves 21 and 22 and the pair of shoulder main grooves 23 and 24 formed outward of the center main grooves 21 and 22 in the tire axial direction. The center main groove 21 and the shoulder main groove 23 are formed in a region on a ground contact end E1 side of the tire equator CL, and the center main groove 22 and the shoulder main groove 24 are formed in a region on a ground contact end E2 side of the tire equator CL. In the present embodiment, the center main groove 22 has a shape corresponding to the shape of the center main groove 21 rotated by 180° on the left and right sides of the tire equator CL, and the shoulder main groove 24 has a shape corresponding to the shape of the shoulder main groove 23 rotated by 180° on the left and right sides of the tire equator CL.

The center main grooves 21 and 22 and the shoulder main grooves 23 and 24 are formed straight in the tire circumferential direction without bending in the tire axial direction. In this case, water on the road surface is likely to enter interiors of the center main grooves 21 and 22 and the shoulder main grooves 23 and 24, and drainage performance can be improved.

A sum of widths of four main grooves is, for example, 15% or more of a length W in the tire axial direction from the ground contact end E1 to the ground contact end E2 (hereinafter referred to as a “ground contact width W”). In this case, water on the road surface is likely to enter each main groove, and the drainage performance can be improved. The sum of the widths of the four main grooves is, for example, 30% or less of the ground contact width W. This improves block rigidity and readily ensures steering stability. Therefore, the sum of the widths of the four main grooves is, for example, 15% or more and 30% or less of the ground contact width W. In the present description, the width of a groove refers to the width of the groove on a profile surface α along the ground contact surface of the tread 10 (see FIGS. 4 and 5), unless otherwise mentioned.

In the present embodiment, the center main grooves 21 and 22 are formed so that the widths of the center main grooves are larger than the widths of the shoulder main grooves 23 and 24. The center main grooves 21 and 22 formed inward in the tire axial direction have a shape that significantly influences the drainage performance, and the drainage performance can improve as the widths of the center main grooves 21 and 22 increase. Accordingly, the drainage performance can be further improved by making the widths of the center main grooves 21 and 22 larger than the widths of the shoulder main grooves 23 and 24. The width of the center main grooves 21 and 22 is, for example, 6 mm or more, and 15 mm or less, and the width of the shoulder main grooves 23 and 24 is, for example, 5 mm or more, and 12 mm or less. Furthermore, the center main grooves 21 and 22 may have a width that is substantially equal to or smaller than the width of the shoulder main grooves 23 and 24.

FIG. 4 shows a cross-sectional view of the center main groove 21. As shown in FIG. 4, in the axial cross-sectional view of the tread 10, the center main groove 21 includes groove walls 21A and 21B extending to be inclined relative to a normal perpendicular to the profile surface α of the tread 10. The groove wall 21A forms a groove wall of the center main groove 21 on an outer side in the tire axial direction, and the groove wall 21B forms a groove wall of the center main groove 21 on an inner side in the tire axial direction. The groove walls 21A and 21B are formed from the profile surface α of the tread 10 to the vicinity of a groove bottom of the center main groove 21.

Here, an inclination angle θ_{21A} of the groove wall 21A, which is the groove wall on the outer side in the tire axial direction, relative to the normal perpendicular to the profile surface α of the tread 10 is smaller than an inclination angle θ_{21B} of the groove wall 21B, which is the groove wall on the inner side in the tire axial direction, relative to the normal perpendicular to the profile surface α of the tread 10. Consequently, for example, even if the tread 10 is thinned and the depth of the center main groove 21 is reduced, the groove volume of the outer portion of the center main groove 21 in the tire axial direction can still be increased. As a result, the amount of water entering the center main groove 21 during travel increases, thus improving the drainage performance. Furthermore, by making the inclination angle θ_{21B} larger than the inclination angle θ_{21A}, the rigidity of the center land portion 30 can be improved. As a result, the steering stability can be improved.

From the viewpoint of increasing the groove volume of the center main groove 21 while securing the rigidity of the first middle land portion 40, the inclination angle θ_{21A} is preferably 5° or more and 15° or less, more preferably 7° or more and 13° or less, and further preferably 9° or more and 11° or less. In addition, from the viewpoint of increasing the rigidity of the center land portion 30 while securing the groove volume of the center main groove 21, the inclination angle θ_{21B} is preferably 15° or more and 25° or less, more preferably 17° or more and 23° or less, and further preferably 19° or more and 21° or less. Also, a difference (θ_{21B}-θ_{21A}) between θ_{21B} and θ_{21A} is preferably 5° or more, more preferably 7° or more, and further preferably 10° or more. An upper limit of the difference (θ_{21B}-θ_{21A}) between θ_{21B} and θ_{21A} is, for example, 20°.

A depth D₂₁ of the center main groove 21 is, for example, 5 mm or more and 10 mm or less, and may be 6 mm or more and 9 mm or less. In general, as the depth D₂₁ of the center main groove 21 decreases, the groove volume of the center main groove 21 tends to decrease, and the drainage performance tends to deteriorate. In the present embodiment, however, as described above, the inclination angle θ_{21A} of the groove wall 21A is smaller than the inclination angle θ_{21B} of the groove wall 21B. Consequently, even if the depth D₂₁ of the center main groove 21 is small, the groove volume of the center main groove 21 can be secured and the drainage performance can be improved. In other words, the effect of the present disclosure is particularly evident when the depth D₂₁ of the center main groove 21 is small due to thinning of the tread 10 or similar changes. Note that the groove depth refers to the length in the tire radial direction from the profile surface α along the ground contact surface of the tread 10 to the deepest portion of the groove, unless otherwise mentioned.

FIG. 5 shows a cross-sectional view of the shoulder main groove 23. As shown in FIG. 5, in the axial cross-sectional view of the tread 10, the shoulder main groove 23 includes groove walls 23A and 23B extending to be inclined relative to the normal perpendicular to the profile surface α of the tread 10. The groove wall 23A forms a groove wall of the shoulder main groove 23 on the outer side in the tire axial direction, and the groove wall 23B forms a groove wall of the shoulder main groove 23 on the inner side in the tire axial direction. The groove walls 23A and 23B are formed from the profile surface α of the tread 10 to the vicinity of a groove bottom of the shoulder main groove 23.

In the present embodiment, as in the case of the center main groove 21, the shoulder main groove is formed so that an inclination angle θ_{23A} of the groove wall 23A, which is the groove wall on the outer side in the tire axial direction, relative to the normal perpendicular to the profile surface α of the tread 10 is smaller than an inclination angle θ_{23B} of the groove wall 23B, which is the groove wall on the inner side in the tire axial direction, relative to the normal perpendicular to the profile surface α of the tread 10. Consequently, for example, even if the tread 10 is thinned and the depth of the shoulder main groove 23 is reduced, the groove volume of the outer portion of the shoulder main groove 23 in the tire axial direction can still be increased. As a result, the amount of water entering the shoulder main groove 23 during travel increases, thus improving the drainage performance.

Furthermore, as described above, the inclination angle θ_{21A} of the groove wall 21A, which is the groove wall of the center main groove 21 on the outer side in the tire axial direction, is small, which may lead to a reduction in the rigidity of the first middle land portion 40. Therefore, by making the inclination angle θ_{23B} larger than the inclination angle θ_{23A}, the rigidity of the first middle land portion 40 can be secured and the steering stability can be improved.

From the viewpoint of increasing the groove volume of the shoulder main groove 23 while securing the rigidity of the first shoulder land portion 60, the inclination angle θ_{23A} is preferably 5° or more and 15° or less, more preferably 7° or more and 13° or less, and further preferably 9° or more and 11° or less. Furthermore, from the viewpoint of increasing the rigidity of the first middle land portion 40 while securing the groove volume of the shoulder main groove 23, the inclination angle θ_{23B} is preferably 15° or more and 25° or less, more preferably 17° or more and 23° or less, and further preferably 19° or more and 23° or less. Also, a difference (θ_{23B}-θ_{23A}) between θ_{23B} and θ_{23A} is preferably 5° or more, more preferably 7° or more, and further preferably 10° or more. An upper limit of the difference (θ_{23B}-θ_{23A}) between θ_{23B} and θ_{23A} is, for example, 20°.

In addition, the inclination angle θ_{23A} may be equal to or different from the inclination angle θ_{21A} of the groove wall 21A, which is the groove wall of the center main groove 21 on the outer side in the tire axial direction. Similarly, the inclination angle θ_{23B} may be equal to or different from the inclination angle θ_{21B} of the groove wall 21B, which is the groove wall of the center main groove 21 on the inner side in the tire axial direction. In the present embodiment, the inclination angle θ_{23A} and the inclination angle θ_{21A} are substantially equal, and the inclination angle θ_{23B} and the inclination angle θ_{21B} are substantially equal.

A depth D₂₃ of the shoulder main groove 23 is, for example, 5 mm or more and 10 mm or less, and may be 6 mm or more and 9 mm or less. In general, as in the case of the center main groove 21, the inclination angle θ_{23A} of the groove wall 23A is smaller than the inclination angle θ_{23B} of the groove wall 23B. Consequently, even if the depth D₂₃ of the shoulder main groove 23 is small, the groove volume of the shoulder main groove 23 can be secured and the drainage performance can be improved. In other words, the effect of the present disclosure is particularly evident when the depth D₂₃ of the shoulder main groove 23 is small due to the thinning of the tread 10 or similar changes.

The depth D₂₃ of the shoulder main groove 23 may be equal to the depth D₂₁ of the center main groove 21, but in the present embodiment, the shoulder main groove 23 is formed to have a depth D₂₃ smaller than the depth D₂₁ of the center main groove 21. In other words, the center main groove 21 is formed so that the depth D₂₁ of the center main groove 21 is larger than the depth D₂₃ of the shoulder main groove 23. As described above, the shape of the center main groove 21 formed inward in the tire axial direction significantly influences the drainage performance. Therefore, by making the depth D₂₁ of the center main groove 21 larger than the depth D₂₃ of the shoulder main groove 23, the drainage performance can be further improved.

A ratio (D₂₁/D₂₃) of the depth D₂₁ of the center main groove 21 to the depth D₂₃ of the shoulder main groove 23 is, for example, 1.01 or more, and may be 1.02 or more. In this case, the drainage performance can be further improved.

As shown in FIG. 3, the tread 10 includes the center land portion 30 partitioned by the center main grooves 21 and 22, the first middle land portion 40 partitioned by the center main groove 21 and the shoulder main groove 23, and the second middle land portion 50 partitioned by the center main groove 22 and the shoulder main groove 24. Furthermore, the tread 10 includes the first shoulder land portion 60 placed opposite the first middle land portion 40 via the shoulder main groove 23 in the tire axial direction, and the second shoulder land portion 70 placed opposite the second middle land portion 50 via the shoulder main groove 24 in the tire axial direction. The center land portion 30, the first middle land portion 40, the second middle land portion 50, the first shoulder land portion 60, and the second shoulder land portion 70 are formed continuously in the tire circumferential direction.

As described above, the mounting direction of the pneumatic tire 1 on the vehicle is not specified, and the pneumatic tire is a point-symmetrical tire in which the tread pattern and the shape of the tire side surface remain unchanged regardless of the direction in which the pneumatic tire is mounted on the vehicle. Therefore, the shape of the second middle land portion 50 is the same as the shape of first middle land portion 40 rotated about any point on the tire equator CL, and the shape of the second shoulder land portion 70 is the same as the shape of the first shoulder land portion 60 rotated about any point on the tire equator CL. Therefore, in the following, the center land portion 30, the first middle land portion 40 and the first shoulder land portion 60 will be described, and the description of the second middle land portion 50 and the second shoulder land portion 70 will be omitted. In the following, as shown in FIG. 2, a first direction in the tire circumferential direction may be referred to as “Y1 direction” and a second direction may be referred to as “Y2 direction”.

### [Center Land Portion 30]

As shown in FIG. 3, the center land portion 30 is formed on the tire equator CL. In the present embodiment, a middle portion of the center land portion 30 in the tire axial direction is placed on the tire equator CL. A width of the center land portion 30 is, for example, 5% or more, and 30% or less of the ground contact width W.

In the center land portion 30, center sipes 31 communicating with the center main grooves 21 and 22, respectively, are formed at intervals in the tire circumferential direction. The center sipes 31 have a substantially uniform width, for example, over a length direction. In the present description, the sipes refer to grooves with a width of less than 1.5 mm. The width of the center sipes 31 is, for example, 0.5 mm or more and 1.0 mm or less.

Each center sipe 31 has a substantially S-shape in planar view of the center land portion 30. Specifically, the center sipe 31 includes a bent portion 31A bent to protrude on one side, in the tire circumferential direction, of a position of each of opposite ends of the center sipe 31 in the tire circumferential direction, in planar view of the center land portion 30. When the center sipe 31 includes the bent portions 31A, strain applied to the center sipe 31 during travel is distributed, and ground contact pressure of the center land portion 30 is distributed. As a result, for example, steering stability improves. In the present embodiment, the bent portions 31A are formed on opposite sides, respectively, of the center sipe 31 in the length direction.

In the present embodiment, only the center sipes 31 are formed in the center land portion 30, and no grooves having a width of 1.5 mm or more are formed. This can increase the ground contact area of the tread 10 and improve grip performance on dry road surfaces. As a result, even if structural members such as the tread 10 and the sidewalls 11 are thinned to reduce the lateral rigidity of the tire, steering stability on dry road surfaces can still be improved.

### [First Middle Land Portion 40]

As shown in FIG. 3, the first middle land portion 40 is placed opposite the center land portion 30 via the center main groove 21 in the tire axial direction and placed opposite the first shoulder land portion 60 via the shoulder main groove 23 in the tire axial direction. A width of the first middle land portion 40 is, for example, 5% or more, and 30% or less, of the ground contact width W.

In the first middle land portion 40, middle slits 41 are formed at intervals in the tire circumferential direction. Each middle slit 41 communicates with the shoulder main groove 23 and is formed inside the first middle land portion 40 and does not communicate with the center main groove 21. The middle slit 41 has a substantially uniform width, for example, over the length direction. In the present description, slits refer to grooves with a width of 1.5 mm or more. The width of the middle slits 41 is, for example, 2 mm or more and 5 mm or less.

The middle slit 41 extends inward in the tire axial direction in a direction inclined along the Y2 direction relative to the tire axial direction, excluding the vicinity of a portion of the middle slit 41 that communicates with the shoulder main groove 23. An inclination angle of the middle slit 41 to the tire axial direction is, for example, 10° or more, and 70° or less, or may be 20° or more, and 60° or less.

As described above, the middle slit 41 does not communicate with the center main groove 21. Consequently, the rigidity of the first middle land portion 40 on an inner side in the tire axial direction improves. As a result, for example, steering stability improves. Furthermore, since the middle slits 41 do not communicate with the center main groove 21, the ground contact area of the tread 10 can be increased, and the grip performance on dry road surfaces can be improved. The length of the first middle land portion 40 in the tire axial direction is, for example, 50% or more, and 90% or less, of the width of the first middle land portion 40. In addition, the length of the slit (the same applies to the sipe) in the tire axial direction refers to the length in the tire axial direction between opposite ends of the slit (sipe) in the tire axial direction.

The middle slit 41 includes a bent portion 41A bent to protrude on one side, in the tire circumferential direction, of a position of each of opposite ends of the middle slit 41 in the tire circumferential direction, in planar view of the first middle land portion 40. When the middle slit 41 includes the bent portion 41A, the groove volume can be readily secured, and on-snow performance can be improved, for example, because snow on the road surface can more easily enter the middle slit 41.

In the first middle land portion 40, a middle sipe 42 is formed to communicate with each of the center main groove 21 and the shoulder main groove 23. Two of middle sipes 42 are formed between two middle slits 41 that are adjacent to each other in the tire circumferential direction. That is, slits and sipes are formed repeatedly in the order of the middle slit 41, middle sipe 42, and middle sipe 42 in the Y1 direction in the tire circumferential direction.

The middle sipe 42 has a substantial S-shape in planar view of the first middle land portion 40 in the same manner as the center sipe 31. Specifically, the middle sipe 42 has a bent portion bent to protrude on one side in the tire circumferential direction of positions of opposite ends of the middle sipe 42 in the tire circumferential direction in planar view of the first middle land portion 40. When the middle sipe 42 has the above shape, strain applied to the middle sipe 42 during travel is distributed, and ground contact pressure of the first middle land portion 40 is distributed. As a result, for example, the steering stability improves. In the present embodiment, the bent portions are formed on opposite sides, respectively, of the middle sipe 42 in the length direction.

### [First Shoulder Land Portion 60]

As shown in FIG. 3, the first shoulder land portion 60 is located opposite the first middle land portion 40 via the shoulder main groove 23 in the tire axial direction. A width of the ground contact surface of the first shoulder land portion 60 is, for example, 10% or more, and 30% or less, of the ground contact width W.

The first shoulder land portion 60 is provided with a shoulder sub groove 61 extending in the tire circumferential direction and having a width smaller than that of the shoulder main groove 23, and shoulder slits 62 extending outward from the shoulder sub groove 61 in the tire axial direction. Furthermore, the first shoulder land portion 60 is provided with communication sipes 63 located opposite the shoulder slits 62 via the shoulder sub groove 61 and communicating with the shoulder main groove 23.

As described above, thinning the structural members such as the tread 10 and the sidewalls 11 to reduce the weight of the tire tends to reduce the lateral rigidity of the tire and impair steering stability. In the pattern of the present embodiment, a void ratio, which refers to an area ratio of grooves to the surface area of the tread 10, is reduced, for example, by omitting slits in the center land portion 30, and as a result, the ground contact area of the tread 10 is increased. This improves the grip performance mainly on dry road surfaces and ensures steering stability. On the other hand, if the void ratio of the tread 10 is reduced, less snow enters the grooves on a snow-covered road surface, resulting in a decrease in snow pillar shear force, that is, the force that helps grip and compress the snow, thereby impairing the on-snow performance.

Therefore, by providing the shoulder sub groove 61 extending in the tire circumferential direction on the first shoulder land portion 60 as in the present embodiment, the shoulder sub groove 61 grips and compresses the snow during travel on the snow-covered road surface. This increases the snow pillar shear force and improves the on-snow performance. In other words, providing the shoulder sub groove 61 in a pattern of the tread 10 with a reduced void ratio enables both the steering stability on dry road surfaces and the improved on-snow performance.

The shoulder sub groove 61 extends in the tire circumferential direction and has a uniform width around the entire circumference. The width of the shoulder sub groove 61 is preferably 0.7% or more, and more preferably 0.8% or more, of the ground contact width W of the tread 10. By setting the width of the shoulder sub groove 61 to 0.7% or more of the ground contact width W of the tread 10, the snow pillar shear force can be further increased and the on-snow performance can be further improved. Furthermore, the width of the shoulder sub groove 61 is preferably 2.0% or less, and more preferably 1.8% or less, of the ground contact width W of the tread 10. Setting the width of the shoulder sub groove 61 to 2.0% or less of the ground contact width W of the tread 10 suppresses excessive increase in void ratio and helps maintain steering stability on dry road surfaces. Therefore, the width of the shoulder sub groove 61 is preferably 0.7% or more and 2.0% or less, and more preferably 0.8% or more and 1.8% or less, of the ground contact width W of the tread 10.

The shoulder sub groove 61 is formed at a position located at a predetermined distance outward in the tire axial direction from a tire axial inner end of the first shoulder land portion 60. Specifically, a length in the tire axial direction between the tire axial inner end of the shoulder sub groove 61 and the tire axial outer end of the shoulder main groove 23 is preferably 5 mm or more, and more preferably 6 mm or more. In this case, securing the rigidity of a region of the first shoulder land portion 60 located inward of the shoulder sub groove 61 in the tire axial direction can suppress damage to that region. Furthermore, a length in the tire axial direction between the tire axial inner end of the shoulder sub groove 61 and the tire axial outer end of the shoulder main groove 23 is preferably 10 mm or less, and more preferably 9 mm or less. In this case, snow can easily enter the shoulder sub groove 61, enabling further improved on-snow performance. Therefore, the length in the tire axial direction between the tire axial inner end of the shoulder sub groove 61 and the tire axial outer end of the shoulder main groove 23 is preferably 5 mm or more and 10 mm or less, and more preferably 6 mm or more and 9 mm or less.

The depth of the shoulder sub groove 61 is smaller than the depth of the shoulder main groove 23 and is, for example, 2 mm or more and 6 mm or less. If the depth of the shoulder sub groove 61 is within the above range, the on-snow performance can be further improved while securing steering stability.

Multiple shoulder slits 62 extending outward from the shoulder sub groove 61 in the tire axial direction are formed at intervals in the tire circumferential direction. The shoulder slits 62 are formed outward in the tire axial direction beyond the ground contact end E1. The shoulder slits 62 have a substantially uniform groove width, for example, over the length direction. The width of each shoulder slit 62 may be larger than the width of each middle slit 41 provided in the first middle land portion 40 and is, for example, 2.5 mm or more and 6 mm or less.

The depth of the deepest portion of each shoulder slit 62 is preferably larger than the depth of the shoulder sub groove 61. The depth of the deepest portion of the shoulder slit 62 is, for example, 4 mm or more and 9 mm or less. If the depth of the shoulder slit 62 is within the above range, the on-snow performance can be further improved.

Furthermore, in the present embodiment, the shoulder slit 62 includes a raised portion 62A with the groove bottom raised outward in the tire radial direction, in the vicinity of a portion communicating with the shoulder sub groove 61. That is, the shoulder slit 62 is formed so that the depth of an inner region of the shoulder slit 62 in the tire axial direction is smaller than that of another portion. Providing the raised portion 62A improves the rigidity of the first shoulder land portion 60. As a result, for example, steering stability can be improved. The depth of the region of the shoulder slit 62 where the raised portion 62A is formed is, for example, 10% or more and 80% or less, and may be 20% or more and 70% or less, of the depth of the deepest portion of the shoulder slit 62.

In addition, the length of the raised portion 62A in the tire axial direction is, for example, 3% or more and 20% or less, and may be 5% or more and 10% or less, of the width of the ground contact surface of the first shoulder land portion 60. Note that the shoulder slit 62 does not have to include the raised portion 62A.

The shoulder slits 62 communicate with the shoulder sub groove 61 as described above, which helps water in the shoulder sub groove 61 to flow outward in the tire axial direction. As a result, the drainage performance can be further improved.

The communication sipes 63 are located opposite the shoulder slits 62 via the shoulder sub groove 61 and communicate with the shoulder sub groove 61 and the shoulder main groove 23. The communication sipes 63 have a substantially uniform width, for example, over the length direction. The width of the communication sipes 63 is, for example, 0.5 mm or more and 1.0 mm or less. In addition, the depth of the communication sipes 63 is, for example, 2 mm or more and 8 mm or less. In the present embodiment, the communication sipes 63 are provided at positions located opposite all of the shoulder slits 62 via the shoulder sub groove 61.

Furthermore, in the first shoulder land portion 60, shoulder sipes 64 extending outward from the shoulder sub groove 61 in the tire axial direction are formed, in addition to the shoulder sub groove 61, the shoulder slits 62 and the communication sipes 63. Two of the shoulder sipes 64 are formed between two shoulder slits 62 that are adjacent to each other in the tire circumferential direction. In other words, slits and sipes are repeatedly formed in the order of the shoulder slit 62, shoulder sipe 64, and shoulder sipe 64 toward the Y1-direction in the tire circumferential direction. The shoulder sipes 64 are formed outward in the tire axial direction beyond the ground contact end E1 and shorter than the shoulder slits 62. Providing the shoulder sipes 64 increases a grip force on a road surface during travel on the snow-covered road surface and improves the on-snow performance.

In addition, the above embodiment may be appropriately changed to such an extent that the purpose of the present disclosure does not change. For example, in the above embodiment, in both the center main groove 21 and the shoulder main groove 23, the inclination angles θ_{21A} and θ_{23A} of the groove walls 21A and 23A on the outer side in the tire axial direction are smaller than the inclination angles θ_{21B} and θ_{23B} of the groove walls 21B and 23B on the inner side in the tire axial direction, which is not limited thereto. Specifically, only in the center main groove 21, the inclination angle θ_{21A} of the groove wall 21A on the outer side in the tire axial direction may be smaller than the inclination angle θ_{21B} of the groove wall 21B on the inner side in the tire axial direction, or only in the shoulder main groove 23, the inclination angle θ_{23A} of the groove wall 23A on the outer side in the tire axial direction may be smaller than the inclination angle θ_{23B} of the groove wall 23B on the inner side in the tire axial direction. Furthermore, in both the center main groove 21 and the shoulder main groove 23, if the inclination angles θ_{21A} and θ_{23A} of the groove walls 21A and 23A on the outer side in the tire axial direction are smaller than the inclination angles θ_{21B} and θ_{23B} of the groove walls 21B and 23B on the inner side in the tire axial direction, the effect of the present disclosure is more particularly exerted.

In the above embodiment, the shape of the second middle land portion 50 corresponds to the shape of the first middle land portion 40 rotated about an arbitrary point on the tire equator CL, and the shape of the second shoulder land portion 70 corresponds to the shape of the first shoulder land portion 60 rotated about an arbitrary point on the tire equator CL, which is not limited thereto. In other words, the tread 10 may have different tread patterns on the left and right sides of the tire equatorial CL.

Furthermore, in the above embodiment, the steel reinforcement layer 20 is placed only on the outer side of the bead filler in the tire axial direction and may be placed on the inner side of the bead filler in the tire axial direction in addition to the outer side of the bead filler in the tire axial direction. In this case, the lateral rigidity of the tire can be further improved.

### REFERENCE SIGNS LIST

1 pneumatic tire
10 tread
11 sidewall
12 side rib
13 bead
14, 14A, 14B carcass ply
15 inner liner
16 bead core
17 bead filler
18 belt
19 cap ply
20 steel reinforcement layer
21, 22 center main groove
21A, 21B groove wall
23, 24 shoulder main groove
23A, 24B groove wall
30 center land portion
31 center sipe
31A bent portion
40 first middle land portion
41 middle slit
41A bent portion
42 middle sipe
50 second middle land portion
60 first shoulder land portion
61 shoulder sub groove
62 shoulder slit
62A raised portion
63 communication sipe
64 shoulder sipe
70 second shoulder land portion
CL tire equator
E1, E2 ground contact end

1. A pneumatic tire, comprising:
a tread,
a pair of sidewalls arranged on opposite sides of the tread,
a pair of beads arranged inward of the sidewalls in a tire radial direction, and
a carcass ply extended between the pair of beads, wherein the tread includes a center main groove extending in a tire circumferential direction, and a shoulder main groove placed outward of the center main groove in a tire axial direction, and extending in the tire circumferential direction,
in at least one of the center main groove and the shoulder main groove, an inclination angle of a groove wall on an outer side in the tire axial direction, relative to a normal perpendicular to a profile surface of the tread, is smaller than an inclination angle of a groove wall on an inner side in the tire axial direction, relative to the normal perpendicular to the profile surface of the tread,
each of the beads includes a bead core and a bead filler extending outward from the bead core in the tire radial direction, and
a steel reinforcement layer including steel cords is placed outward of the bead filler in the tire axial direction.

2. The pneumatic tire according to claim 1, wherein the tread includes a shoulder land portion placed outward of the shoulder main groove in the tire axial direction, and
the shoulder land portion is provided with a shoulder sub groove extending in the tire circumferential direction and having a groove width smaller than a groove width of the shoulder main groove.

3. The pneumatic tire according to claim 2, wherein a length in the tire axial direction between a tire axial inner end of the shoulder sub groove and a tire axial outer end of the shoulder main groove is 5 mm or more and 10 mm or less.

4. The pneumatic tire according to claim 1, wherein a tire radial outer end of the steel reinforcement layer is placed inside a tire maximum width position in the tire radial direction and placed at a position of 5 mm or more and 10 mm or less outward from a tire radial outer end of the bead filler in the tire radial direction.

5. The pneumatic tire according to claim 1, wherein in at least one of the center main groove and the shoulder main groove,
the inclination angle of the groove wall on the outer side in the tire axial direction, relative to the normal perpendicular to the profile surface of the tread, is 5° or more and 15° or less, and
the inclination angle of the groove wall on the inner side in the tire axial direction, relative to the normal perpendicular to the profile surface of the tread, is 15° or more and 25° or less.

6. The pneumatic tire according to claim 1, wherein a ratio (H/LS) of a tire cross-sectional height (H) based on a bead baseline (BL) to a tire cross-sectional maximum width (LS) is 0.48 or more and 0.60 or less.

7. The pneumatic tire according to claim 1, wherein the number of the steel cords driven in the steel reinforcement layer is 15 cords/inch or more and 25 cords/inch or less.

8. The pneumatic tire according to claim 2, wherein a width of the shoulder sub groove is 0.8% or more and 1.8% or less of a ground contact width (W) of the tread.

9. The pneumatic tire according to claim 2, wherein a depth of the shoulder sub groove is smaller than a depth of the shoulder main groove.

10. The pneumatic tire according to claim 2, wherein the shoulder land portion is provided with shoulder slits extending outward from the shoulder sub groove in the tire axial direction.

11. The pneumatic tire according to claim 10, wherein each of the shoulder slits includes a raised portion with a groove bottom raised outward in the tire radial direction, in a portion communicating with the shoulder sub groove.

12. The pneumatic tire according to claim 10, wherein the shoulder land portion is provided with communication sipes located opposite the shoulder slits via the shoulder sub groove and communicating with the shoulder sub groove and the shoulder main groove.

13. The pneumatic tire according to claim 10, wherein the shoulder land portion is provided with shoulder sipes extending outward from the shoulder sub groove in the tire axial direction, and
two of the shoulder sipes are formed between two of the shoulder slits that are adjacent to each other in the tire circumferential direction.
